(19) United States
(12) Patent Application Publication
(10) Pub. No.: US 2002/0146556 A1
(43) Pub. Date: Oct. 10, 2002

(54) Resistor foil

(75) Inventors: Joel W. Pankow, Mentor-on-the-Lake, OH (US); Michael A. Centanni, Parma, OH (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: GA-TEK Inc. (dba Gould Electronics Inc.)

(21) Appl. No.: 09/825,803

(22) Filed: Apr. 4, 2001

(51) Int. Cl. B32B 15/08

(52) U.S. Cl. 428/336; 428/463

(57) ABSTRACT

A resistor foil comprised of a layer of copper foil and a coating of an organic molecular semiconductor material on one side of the copper foil.

### FIELD OF THE INVENTION

The present invention relates to multi-layer printed circuit boards and, more particularly, to a resistive component usable in forming boards with embedded resistive layers.

### BACKGROUND OF THE INVENTION

A basic component of a printed circuit board is a dielectric layer having a sheet of copper foil bonded thereto. Through a subtractive process that includes one or more etching steps, portions of the copper foil are etched away to leave a distinct pattern of conductive lines and formed elements on the surface of the dielectric layer. Multi-layer printed circuit boards are formed by stacking and joining two or more of the aforementioned dielectric layers having printed circuits thereon. Many printed circuit boards include conductive layers containing patterned components that perform like specific, discreet components. One such discreet component is a resistive element formed from a resistor foil.

A resistor foil is basically a copper foil having a thin layer of resistive material, typically a metal or metal alloy deposited onto one surface thereof. The resistor foil is attached to a dielectric substrate with the resistive material adhered to the dielectric substrate. Using conventionally known masking and etching techniques, the copper foil and resistive material are etched away to produce a trace line of copper with the resistive material therebelow on the surface of the dielectric. A section of the copper layer is removed leaving only the resistive material on the surface connecting the two separated ends of the copper. Because the material forming the resistive layer typically has a conductivity less than copper, it essentially acts as a resistor between the separated ends of the copper trace lines. The thickness and width of the resistive layer, as well as the length of the resistive layer disposed between the ends of the copper traces, affect the resistance of the resistive element so formed.

The present invention represents an improvement over resistor foils known heretofore and provides a resistor foil having an organic semiconductor material on a copper layer for use in forming resistive elements.

### SUMMARY OF THE INVENTION

In accordance with a preferred embodiment of the present invention, there is provided a resistor foil, comprised of a copper layer having a first side and a second side, and a layer of an organic semiconductor having a thickness of between 100 Å and 500 Å on said first side.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is an enlarged, partially-sectioned, perspective view of a resistor foil, illustrating a preferred embodiment of the present invention;

FIG. 2 is an enlarged, partially-sectioned, perspective view of the resistor foil shown in FIG. 1, showing the resistor foil attached to a dielectric prepreg;

FIG. 3 is a perspective view showing a resistive element formed from the resistive foil shown in FIG. 2;

FIG. 4 is an enlarged view of area 4-4 of FIG. 3; and

FIG. 5 is a schematic representation of the resistive element formed in FIG. 3.

### DETAILED DESCRIPTION OF PREFERRED EMBODIMENT

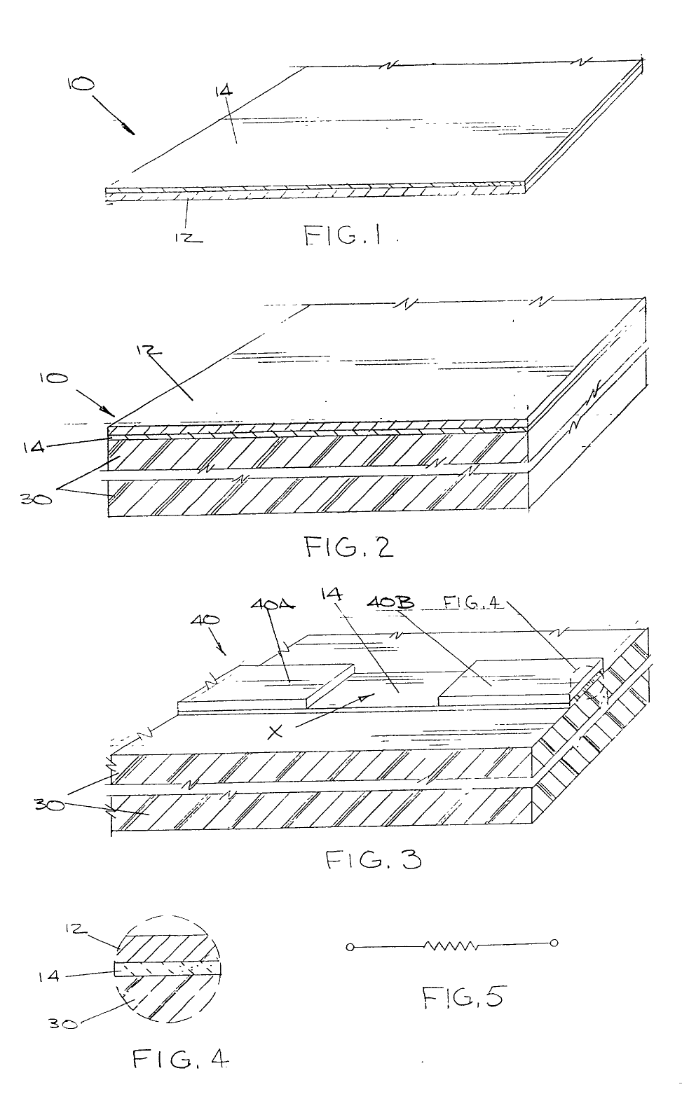

Referring now to FIG. 1, a resistor foil 10, illustrating a preferred embodiment of the present invention is shown. Resistor foil 10 is for use in forming embedded resistive elements in printed circuit boards. Resistor foil 10 is comprised of a copper layer 12, and a first layer 14 of a first resistive material is applied to one side of copper layer 12.

Copper layer 12 is preferably formed of conventional copper foil. Copper foils used with this invention can be made using one of two techniques. Wrought or rolled copper foil is produced by mechanically reducing the thickness of a copper or copper alloy strip or ingot by a process such as rolling. Electrodeposited foil is produced by electrolytically depositing from solution copper ions on a rotating cathode drum and then peeling the deposited foil from the cathode. Electrodeposited copper foils find advantageous application with this invention.

Copper foils typically have nominal thicknesses ranging from about 0.0002 inch to about 0.02 inch. Copper foil thickness is sometimes expressed in terms of weight and typically the foils of the present invention have weights or thicknesses ranging from about ⅛ to about 14 ounces per square foot (oz/ft²). Especially useful copper foils are those having weights of ⅓, ½, 1 or 2 oz/ft².

Electrodeposited copper foils have a smooth or shiny (drum) side and a rough or matte (copper deposit growth front) side. The side or sides of the foil, to which the layer applied by the inventive process overlies, can be a “standard-profile surface,” low-profile surface” or “very-low-profile surface.” Useful embodiments involve the use of foils with low-profile surfaces and very low-profile surfaces. The term “standard-profile surface” is used herein to refer to a foil surface having a Rₜₘ (IPC-MF-150F) of greater than 10.2μ. The term “low-profile surface” refers to a foil surface having a Rₜₘ (IPC-MF-150F) of less than 10.2μ. The term “very-low-profile surface” refers to a foil surface having a Rₜₘ (IPC-MF-150F) of less than 5.1μ. Rₜₘ (IPC-MF-150F) is the mean of the maximum peak-to-valley vertical measurements from each of five consecutive sampling measurements, and can be measured using a SURTRONIC® 3 profilometer marketed by Rank Taylor Hobson, Ltd., Leicester, England.

The present invention finds advantageous application with copper foils of the type heretofore described.

Layer 14 is preferably formed of an organic semiconductor that is deposited onto copper layer 12. Layer 14 can be formed by thin film vacuum deposition, spin casting and other solvent based applications, langmuir-blodgett monolayer application.

Layer 14 is preferably formed of an organic molecular semiconductor. Molecular semiconductors are generally comprised of materials from various general organic molecular semiconductor categories including aromatic hydrocarbons, metallo-organics, metallopthalocyanines, polymers and charge transfer compounds. They have inherent, intrinsic electrical conductivities ranging from that of an insulator (18⁻¹⁸ Ω⁻¹cm⁻¹) to near-metallic conductivity (10² Ω⁻¹cm⁻¹). Actual resistance of a device is controlled through film thickness and distance between conductors. Furthermore, through the introduction of chemical dopants, their intrinsic resistivities can be severely altered resulting in tunable, tailor-made chemical resistors. In addition, certain of these organic molecular semiconductors have the additional feature of enhanced conductivity (lowered resistivity) in the presence of light.

Many of the listed molecular organic semiconductors can be doped with elements or compounds such as oxygen, nitrogen oxides, halogens, benzoquinone, chloranil, fluoranil, bromanil, trifluoroborane.

By way of example, and not limitation, aromatic hydrocarbons and graphite materials that can be used to form layer 14 include naphthalene, anthracene, tetracene, pentacene, hexacene, perylene, phenanthrene, chrysene, triphenylene, pyrene, benzopyrene, violanthrene, coronene, ovalene, graphite and highly oriented pyrolytic graphite (HOPG).

By way of example, and not limitation, organic polymers that can be used to form layer 14 include poly n-vinylcarbozole, polyethylene, polyacetylene, potyphenylene, polyphenylacetylene, polypyrrole, polyacrylonitrile, pyrolyzed polymers (polyacrylonitrile, polyimide, polyvinylmethylketone, polydivinylbenzene, polyvinylidene chrloride) polymethine dyes, polysulfurnitride, polydiacetylene.

By way of example, and not limitation, metallo-organic materials that can be used to form layer 14 include porphyrins, metal-cyano complexes (Pt, Ir and Rh), merocyanines.

By way of example, and not limitation, metallophthalocyanine materials that can be used to form layer 14 include hydrogen based phythalocyanines, as well as metal based phythalocyanines that include the following metals: lithium (Li), beryllium (Be), sodium (Na), magnesium (Mg), aluminum (Al), silicon (Si), phosphorus (P), potassium (K), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), arsenic (As), yttrium (Y), zirconium (Zr), niobium (Nb), molybdenum (Mo), technetium (Tc), ruthenium (Ru), rhodium (Rh), palladium (Pd), silver (Ag), cadmium (Cd), indium (In), tin (Sn), antimony (Sb), barium (Ba), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), gold (Au), mercury (Hg), thallium (Tl), lead (Pb), thorium (Th), protactinium (Pa), uranium (U), neptunium (Np), plutonium (Pu), americium (Am), curium (Cm), berkelium (Bk), californium (Cf), einsteinium (Es) fermium (fm), mendelevium (Md), nobelium (No) and lawrencium (Lw).

By way of example, and not limitation, charge transfer compounds that can be used to form layer 14 include hydrogen based phythalocyanines, as well as metal based phythalocyanines that include combinations of: n-ethyicarbazole, hexamethylbenzene (HMB), tetramethyl-p-phenylene diamine (TMPD), tetrathiotetracene (TTT), tetrathiofulvalene (TTF), tetraselenofulvalene (TSeF), tetramethylthiofulvalene (TMTTF), alkali metals, triethylammonium (TEA), n-methylpyridinium (NMPy), n-methylquinolinium (NMQn), n-methylacridinium (NMAd), trinitrofluorenone (TNF), tetracyanoquinodimethane (TCNQ), 11,11,12,12-tetracyano-naphtho-2,6-quinodimethane (TNAP), tetracyanoethylene (TCNE), tetracyanobenzene, p-chloranil, 2,3-dichloro-5,6-dicyano benzoquinone (DDQ).

Other charge transfer compounds that can be used to form layer 14 include, without limitation, a combination of at least two compounds selected from the group consisting of: n-ethylcarbazole, hexamethylbenzene (HMB), tetramethyl-p-phenylene diamine (TMPD), tetrathiotetracene (TTT), tetrathiofulvalene (TTF), tetraselenofulvalene (TSeF), tetramethylthiofulvalene (TMTTF), alkali metals, triethylammonium (TEA), n-methylpyridinium (NMPy), n-methylquinolinium (NMQn), n-methylacridinium (NMAd), trinitrofluorenone (TNF), tetracyanoquinodimethane (TCNQ), 11,11,12,12-tetracyano-naphtho-2,6-quinodimethane (TNAP), tetracyanoethylene (TCNE), tetracyanobenzene, p-chloranil, 2,3-dichloro-5,6-dicyano benzoquinone (DDQ).

Because of their unique electronic properties, metallophthalocyanines are preferred in forming layer 14, because they possess certain desirable properties, such as, by way of example, they have tunable electrical conductivity ranging from 10⁻¹⁸ to 10⁻⁹ Ω⁻¹cm⁻¹ depending on the metal center, counterion (if any) and level of doping; they are easy to synthesize and prepare as thin films; they readily sublime under heat in vacuum creating uniform, thin films of any desired thickness; they possess exceptional thermal, mechanical and chemical stability and resilience; and they possess strong visible light absorption leading to additional photoconductive properties (decreased resistivity) beyond existing dark conductivity. (Increasing impinging light intensity may further lower such decreased resistance).

Layer 14 of organic semiconductor material preferably has a thickness between 3 Å and 1000 Å, and is applied by vacuum deposition.

Referring now to the use of resistor foil 10 in forming a resistive element; FIG. 3 shows resistor foil 10 adhered to a dielectric substrate 30. Resistor foil 10 may be secured to dielectric substrate 30 using an adhesive (not shown), or adhered to dielectric substrate 30 by a lamination process, wherein dielectric substrate 30 is cured with resistor foil 10 attached thereto. Methods of securing a resistor foil, such as foil 10, are conventionally known, and the particular method used in and of itself is not critical to the present invention.

Resistor foil 10 is attached to dielectric substrate 30 with layer 14 closest to, and facing, substrate 30 (as shown in FIG. 3), and with copper layer 12 exposed. Using conventionally known processes of masking and etching, unwanted areas of copper layer 12 are etched away to leave a trace line 40 on layer 14. A section, designated “X,” of copper layer 12 is removed from trace line 40, by conventional masking and etching techniques, to leave only layer 14 connecting spaced-apart ends 40A, 40B of trace line 40. Typically, an acid solution is used to etch away portions of copper layer 12. Most organic molecular semiconductor materials that may be used to form layer 14 are generally not affected by the acid solutions that are used to etch copper. As a result, layer 14 is not removed during the copper etching process thus resulting in trace line 40 lying on the surface of layer 14.

Layer 14 may be removed using a solvent. Pyridine is a particularly suitable solvent for removing phthalocyanines, and acetonitrile is a suitable solvent for removing charge transfer compounds. Other potential solvents include, by way of example and not limitation, acetone, carbon tetrachloride, benzene, toluene, chloroform, dioxane, tetrahydrofuran, methyl ethyl ketone, diethyl ether, methanol, ethanol, propanol, diethylamine, dimethyl formamide (DMF). Such solvents will not affect the overlying copper layer 12. An acid solution is then used to etch away a portion of a copper line, i.e., section X, down to the organic molecular semiconductor. Section X essentially forms a resistive element between spaced-apart ends 40A, 40B of trace line 40. Any current flow through trace line 40 must necessarily flow through layer 14 of section X.

The present invention thus provides a resistive foil 10 wherein the resistive layer of foil 10 is formed of an organic molecular semiconductor. Such materials have relatively good adhesion to both copper and dielectric substrate materials, and at the same time, provide resistance values not attainable with metal resistive materials.

In this respect, organic, molecular semiconductors have inherent, intrinsic electrical conductivities ranging from that of an insulator (10⁻¹⁸ Ω⁻¹cm⁻¹) to near-metallic conductivity (10² Ω⁻¹cm⁻¹). Actual resistance of a device is controlled through film thickness, width and length. Furthermore, through the introduction of chemical dopants, their intrinsic conductivities can be severely altered resulting in tunable, tailor-made chemical resistors. In addition, certain of these organic molecular semiconductors have the additional feature of enhanced conductivity (lower resistivity) in the presence of light.

The foregoing description discloses specific embodiments of the present invention. These embodiments are described for purposes of illustration only. Numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A resistor foil, comprised of:
a layer of copper foil; and
a coating of an organic molecular semiconductor material on one side of said copper foil.

2. A resistor foil as defined in claim 1, wherein said copper foil is an electrodeposited copper foil.

3. A resistor foil as defined in claim 2, wherein said organic molecular semiconductor material is vacuum deposited onto said copper foil.

4. A resistor foil as defined in claim 3, wherein said organic molecular semiconductor material has a thickness between 3 Å and 1,000 Å.

5. A resistor foil as defined in claim 4, wherein said organic molecular semiconductor material has a thickness between 50 Å and 200 Å.

6. A resistor foil as defined in claim 1, wherein said organic molecular semiconductor material is a metallo-organic.

7. A resistor foil as defined in claim 6, wherein said organic molecular semiconductor material is a metallo-organic selected from the group consisting of porphyrins, metal-cyano complexes (Pt, Ir and Rh), merocyanines.

8. A resistor foil as defined in claim 1, wherein said organic molecular semiconductor material is an aromatic hydrocarbon.

9. A resistor foil as defined in claim 8, wherein said organic molecular semiconductor material is an aromatic hydrocarbon selected from the group consisting of naphthalene, anthracene, tetracene, pentacene, hexacene, perylene, phenanthrene, chrysene, triphenylene, pyrene, benzopyrene, violanthrene, coronene, ovalene, graphite and highly oriented pyrolytic graphite (HOPG).

10. A resistor foil as defined in claim 1, wherein said organic molecular semiconductor material is a metallopthalocyanine.

11. A resistor foil as defined in claim 10, wherein said organic molecular semiconductor material is a metallopthalocyanine selected from the group consisting of hydrogen based phythalocyanines, as well as metal based phythalocyanines that include the following metals: lithium (Li), beryllium (Be), sodium (Na), magnesium (Mg), aluminum (Al), silicon (Si), phosphorus (P), potassium (K), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), arsenic (As), yttrium (Y), zirconium (Zr), niobium (Nb), molybdenum (Mo), technetium (Tc), ruthenium (Ru), rhodium (Rh), palladium (Pd), silver (Ag), cadmium (Cd), indium (In), tin (Sn), antimony (Sb), barium (Ba), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), gold (Au), mercury (Hg), thallium (Tl), lead (Pb), thorium (Th), protactinium (Pa), uranium (U), neptunium (Np), plutonium (Pu), americium (Am), curium (Cm), berkelium (Bk), californium (Cf), einsteinium (Es) fermium (fm), mendelevium (Md), nobelium (No) and lawrencium (Lw).

12. A resistor foil as defined in claim 1, wherein said organic molecular semiconductor material is a polymer.

13. A resistor foil as defined in claim 12, wherein said organic molecular semiconductor material is a polymer selected from the group consisting of poly n-vinylcarbozole, polyethylene, polyacetylene, polyphenylene, polyphenylacetylene, polypyrrole, polyacrylonitrile, pyrolyzed polymers (polyacrylonitrile, polyimide, polyvinylmethylketone, polydivinylbenzene, polyvinylidene chrloride) polymethine dyes, polysulfurnitride, polydiacetylene.

14. A resistor foil as defined in claim 1, wherein said organic molecular semiconductor material is a charge transfer compound.

15. A resistor foil as defined in claim 14, wherein said organic molecular semiconductor material is a charge transfer compound selected from the group consisting of hydrogen based phythalocyanines, as well as metal based phythalocyanines that include combinations of: n-ethylcarbazole, hexamethylbenzene (HMB), tetramethyl-p-phenylene diamine (TMPD), tetrathiotetracene (TTT), tetrathiofulvalene (TTF), tetraselenofulvalene (TSeF), tetramethylthiofulvalene (TMTTF), alkali metals, triethylammonium (TEA), n-methylpyridinium (NMPy), n-methylquinolinium (NMQn), n-methylacridinium (NMAd), trinitrofluorenone (TNF), tetracyanoquinodimethane (TCNQ), 11,11,12,12-tetracyano-naphtho-2,6-quinodimethane (TNAP), tetracyanoethylene (TCNE), tetracyanobenzene, p-chloranil, 2,3-dichloro-5,6-dicyano benzoquinone (DDQ).

16. A resistor foil as defined in claim 14, wherein said charge transfer compound is a combination of at least two compounds selected from the group consisting of: n-ethylcarbazole, hexamethylbenzene (HMB), tetramethyl-p-phenylene diamine (TMPD), tetrathiotetracene (TTT), tetrathiofulvalene (TTF), tetraselenofulvalene (TSeF), tetramethylthiofulvalene (TMTTF), alkali metals, triethylammonium (TEA), n-methylpyridinium (NMPy), n-methylquinolinium (NMQn), n-methylacridinium (NMAd), trinitrofluorenone (TNF), tetracyanoquinodimethane (TCNQ), 11,11,12,12-tetracyano-naphtho-2,6-quinodimethane (TNAP), tetracyanoethylene (TCNE), tetracyanobenzene, p-chloranil, 2,3-dichloro-5,6-dicyano benzoquinone (DDQ).
